(19) United States
(12) Patent Application Publication
(10) Pub. No.: US 2001/0033215 A1
(43) Pub. Date: Oct. 25, 2001

(54) Multi-functional vibration actuator

(75) Inventor: Nobuyasu Sakai, Sendai-shi (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Tokin Corporation, Miyagi (JP)

(21) Appl. No.: 09/841,523

(22) Filed: Apr. 24, 2001

(30) Foreign Application Priority Data
Apr. 25, 2000 (JP) 123798/2000

(51) Int. Cl. H01F 7/10

(52) U.S. Cl. 335/252

(57) ABSTRACT

A multi-functional vibration actuator comprises a magnetic circuit flexibly supported by a suspension fixed to the magnetic circuit, a coil arranged at a gap of the magnetic circuit, and a vibration transmitting portion. The coil includes at least two coils. One of the coils is a main coil. Another coil is an auxiliary coil. Even if the coil jumps out of the uniform magnetic flux distribution of a magnetic pole gap during movement, a uniform magnetic flux is always applied of the coil.

### BACKGROUND OF THE INVENTION

1. Field of the Invention

The present invention relates to a multi-functional vibration actuator that is mostly mounted on a mobile communication apparatus, such as a mobile telephone, and functions to generate a ringing tone, a speech sound, and vibration.

2. Description of the Related Art

Conventional multi-functional vibration actuators have a magnetic circuit composed of a yoke, a permanent magnet and a plate. The magnetic circuit is flexibly supported by a circular and spiral plate spring suspension that is fixed to the periphery of the yoke of the magnetic circuit and a vibration transmitting portion.

A coil includes one normally wound coil and is arranged at a gap of the magnetic circuit. The coil is fixed to U-shape parts provided at random locations in the diameter direction of the vibrating member. A coil wire of the coil is spread over a face of the vibrating member in various shapes without providing negative effects on the vibration of the vibrating member. The wire is attached to random locations of the vibrating member with an elastic material, such as adhesive provided in dots, and is soldered to a terminal board. In the similar manner to the suspension, the vibrating member is fixed to the vibration transmitting portion.

In such a multi-functional vibration actuator, when driving current is supplied to the coil, the magnetic circuit or the coil moves up and down in an axial direction. The vibration transmitting portion becomes a fixed part at low frequencies, and an elastic member at high frequencies, vibrating as a part of the vibrating member. In a vibration mode, the magnetic circuit and the coil fixed to the vibrating member interact with each other and operate at an opposite phase, transmitting vibrations to the outside.

In the conventional multi-functional vibration actuator, the single normally wound coil as the coil is bonded at a random location in the diameter direction of the vibrating member, is inserted to a recess provided at the vibrating member, and is bonded to the top face of a projection formed by a recess, or the like. However, when the coil jumps out of a uniform magnetic flux distribution of a magnetic pole gap to the outside of a magnetic pole during driving, driving force decreases and follow-up properties become insignificant. Accordingly, electric current with respect to driving force becomes nonlinear, losing sound distortion characteristics as an electroacoustic transducer.

### SUMMARY OF THE INVENTION

Accordingly, it is an object of the present invention to provide a multi-functional vibration actuator. Even when the coil jumps out of a uniform magnetic flux distribution of a magnetic pole gap, the vibration actuator has a small decrease in driving force and maintains sufficient coil follow-up properties. The vibration actuator also hardly causes the nonlinearity of electric current with respect to driving force, and does not lose sound distortion characteristics as an electroacoustic transducer.

In order to solve the problems mentioned above, according to the present invention, there is provided a multi-functional vibration actuator in which a coil has a plurality of coils. At least one distortion-improving auxiliary coil is mounted on a main coil, so that a uniform magnetic flux is applied to the coil even when the coil jumps out of the uniform distribution of a magnetic pole gap during driving. Or alternately, the coil is repeatedly non-densely and densely wound at random heights (number of lines), and winding widths (number of layers) are differentiated to add magnetic gradient. Thus, even when the coil jumps out of the uniform magnetic flux distribution of a magnetic pole gap during movement, a uniform magnetic flux is always applied on the coil.

In the multi-functional vibration actuator, a vibrating member has a recess at a random location in the diameter direction thereof. The coil is inserted to the recess or fixed to the top face of a projection formed by the recess. The coil has the same or different wire diameters, wire materials and so forth. The coil is wound densely at the side of the vibrating member to which the coil is fixed. A coil wire is connected in series or in rows with two terminals or three terminals.

Specifically, in a multi-functional vibration actuator in which a magnetic circuit is flexibly supported by a suspension fixed to the vibration transmitting portion, the coil arranged at a gap of the magnetic circuit, and the magnetic circuit, and the coil includes at least two coils.

At least one auxiliary coil may be mounted so as to provide a uniform magnetic flux even when the coil jumps out of the uniform magnetic flux distribution range of a magnetic pole gap during driving.

Moreover, in a multi-functional vibration actuator in which a magnetic circuit is flexibly supported by a suspension fixed to the vibration transmitting portion, the coil arranged at a gap of the magnetic circuit, and the magnetic circuit, the coil has a magnetic gradient by differentiating winding widths at random heights.

The coil may be fixed to the vibrating member. The vibrating member may have a recess at a random location in the diameter direction thereof. The coil may be inserted to the recess or fixed to the top face of a projection formed by the recess.

The coil may be one or more in number. Each coil may be made of the same or different wire diameter, wire material, and so forth.

A coil wire may be connected in series or in parallel with two terminals or three terminals.

The coil wire of the coil may be wound densely at the side of the vibrating member to which the coil is fixed.

The magnetic circuit and the coil fixed to the vibrating member may interact with each other to operate in an opposite phase.

### BRIEF DESCRIPTION OF THE DRAWINGS

FIG. 1 is a cross-sectional view of a conventional multi-functional vibration actuator;

FIG. 2 is a cross-sectional view of normally wound coils in the conventional multi-functional vibration actuator;

FIG. 3A is an arrangement diagram of a coil in a vibrating member of the conventional multi-functional vibration actuator, showing that the coil is fixed to the top face of a projection formed by a recess of the vibrating member;

FIG. 3B is a diagram, showing that the coil is fixed to the recess of the vibrating member;

FIG. 4 is a cross-sectional view of a multi-functional vibration actuator according to an embodiment of the present invention;

FIG. 5A is an arrangement diagram of a coil in the vibrating member of the multi-functional vibration actuator of the present invention, showing that a main coil is inserted to a recess of the vibrating member and an auxiliary coil is also fixed to the top plane of a projection formed by the recess of the vibrating member;

FIG. 5B is an arrangement diagram of a coil in the vibrating member of the multi-functional vibration actuator of the present invention, showing that an auxiliary coil and a main coil are sequentially inserted into a recess of the vibrating member in the vibrating direction thereof at the side of a magnetic circuit and at the side of the vibrating member, respectively;

FIG. 5C is an arrangement diagram of a coil in the vibrating member of the multi-functional vibration actuator of the present invention, showing that a main coil and an auxiliary coil are provided in a recess of the vibrating member parallel to the vibrating direction thereof;

FIG. 6A is a diagram of connecting coils in the multi-functional vibration actuator of the present invention, showing that the coils are connected in series;

FIG. 6B is a diagram of connecting coils in the multi-functional vibration actuator of the present invention, showing that the coils are connected in parallel;

FIG. 6C is a diagram of connecting coils in the multi-functional vibration actuator of the present invention, showing that the coils are connected in series and terminals lead out from a node;

FIG. 7A is another arrangement diagram of coils in the vibrating member of the multi-functional vibration actuator of the present invention, showing that two auxiliary coils are wound at both ends in the height direction of normally wound coils;

FIG. 7B is another arrangement diagram of coils in the vibrating member of the multi-functional vibration actuator of the present invention, showing that the coils are densely wound with a coil at the side of the vibrating member and with another auxiliary coil at the opposite side thereof;

FIG. 7C is another arrangement diagram of coils in the vibrating member of the multi-functional vibration actuator of the present invention, showing that normally wound coils are further wound with an auxiliary coil at the side of the vibrating member; and

FIG. 7D is another arrangement diagram of coils in the vibrating member of the multi-functional vibration actuator of the present invention, showing that the coils are densely wound with a coil at the side of the vibrating member.

### DESCRIPTION OF THE PREFERRED EMBODIMENT

First, a conventional multi-functional vibration actuator will be explained by referring to FIGS. 1 to 3 in order to make the present invention easily understood prior to the explanation of the embodiments of the present invention.

As shown in FIG. 1, a magnetic circuit is composed of a yoke 11, a permanent magnet 13 and a plate 15 and is flexibly supported by a suspension 19 which is a circular spiral plate spring fixed to a vibration transmitting portion 17, in a conventional multi-functional vibration actuator 9. The suspension 19 is fixed to the periphery of the yoke 11 of the magnetic circuit and to the vibration transmitting portion 17.

A coil 25 are fixed with an adhesive or the like to U-shape parts 23 of a vibrating member 61 provided at random locations in the diameter direction of the vibrating member 61 and are arranged at the gaps of the magnetic circuit. A coil wire 27 is spread over the face of the vibrating member 61 in a V shape, U shape, bellows shape or the combination thereof without providing negative effects on the vibration of the vibrating member 61. The coil wire 27 is attached with an elastic material, such as adhesive provided in dots at random locations of the vibrating member 61, and is fixed to a terminal board 29 with solder 31.

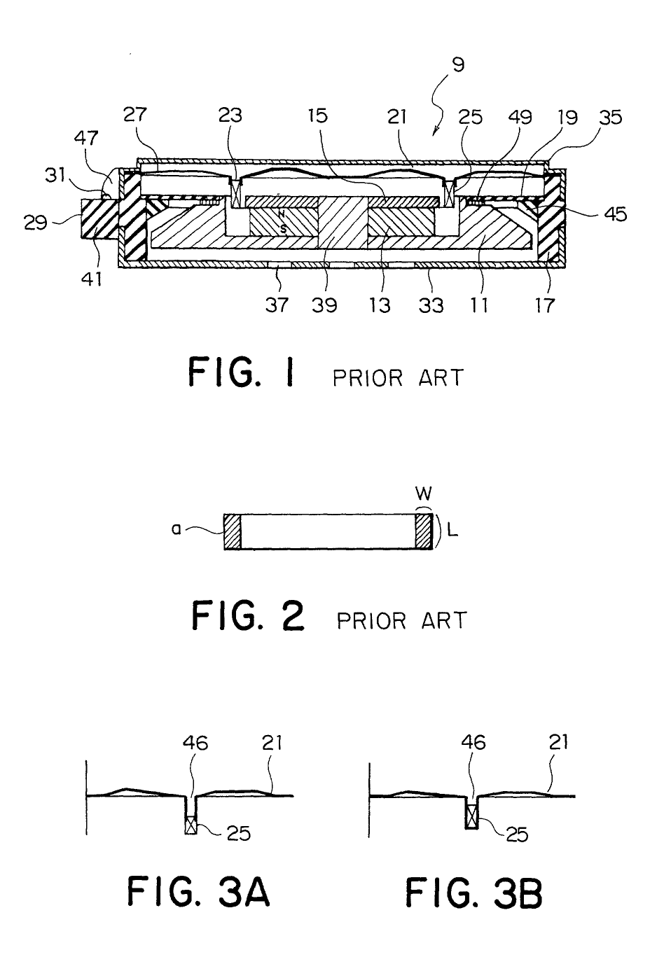

For the coil 25, one normally wound coil is used as shown in FIG. 2. The coil 25 is arranged as shown in FIG. 1 or FIGS. 3A and 3B.

The vibrating member 61 is fixed to the vibration transmitting portion 17 like the suspension 19. When driving current is sent into the coil 25, the magnetic circuit or the coil 25 repeatedly move up and down in an axial direction. The vibration transmitting portion 17 becomes a fixed part at low frequencies, and an elastic member at high frequencies, vibrating as a part of the vibrating member 61. At a vibration mode, the magnetic circuit and the coil 25 fixed to the vibrating member 61 interact with each other to operate at an opposite phase, transmitting vibrations to the outside.

A first cover 33 and a second cover 35 are fixed to the vibration transmitting portion 17 so as to protect a functional part. The first cover 33 has one or more sound emitting holes 37 of a random diameter for air viscous damping action. A center axis 39 is inserted through a center hole of the magnetic circuit.

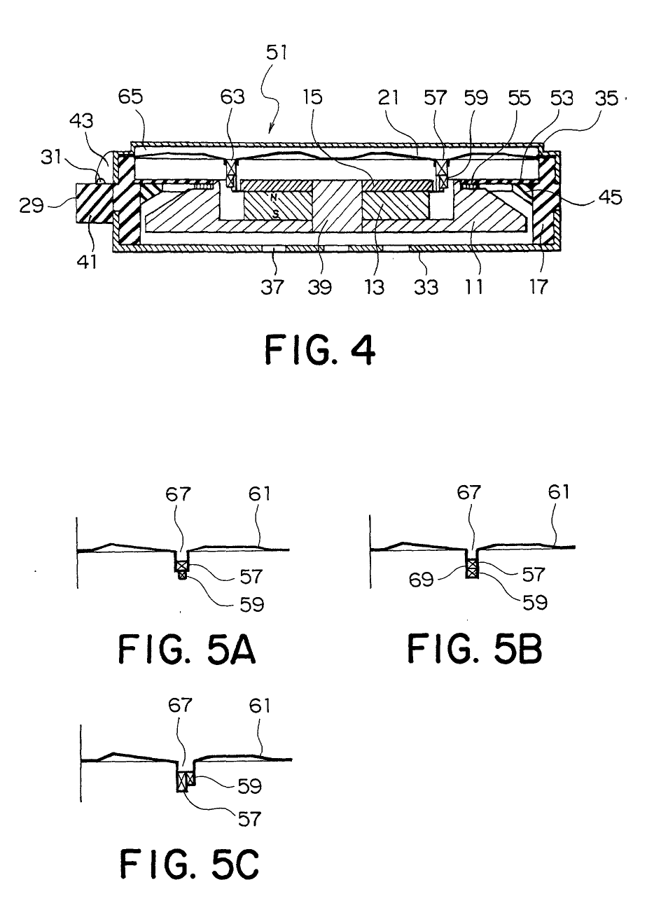

Subsequently, the multi-functional actuator of the embodiments of the present invention will be explained by referring to FIGS. 4 to 7.

### EXAMPLE 1

In reference to FIG. 4, a multi-functional vibration actuator 51 of Example 1 of the present invention has a magnetic circuit in which the disc-shape permanent magnet 13 is sandwiched with the yoke 11 and the plate 15, and has an internal magnetic structure.

The center axis 39 in a bolt or pin shape is inserted through the center hole of the magnetic circuit, coaxially positioning the yoke 11, the permanent magnet 13 and the plate 15 and is fixed by caulking. After coaxially positioning the yoke 11, the permanent magnet 13 and the plate 15, the center axis 39 may be removed. The components of the magnetic circuit are fixed by the attraction of the permanent magnet 13 or by both the attraction and an adhesive or by caulking and so forth.

The suspension 53 is composed of one circular spiral plate spring, flexibly supporting the magnetic circuit. The suspension 53 is fixed to the periphery of the yoke 11 with an elastic material 55, such as a tackiness agent, an adhesive or resin, caulking or the like. The other end thereof is fixed to the vibration transmitting portion 17. On the other hand, the coil has coils 57 and 59 which are fixed with adhesive or the like to highly reliable U-shaped parts 63 at random locations of the vibrating member 61 from which the coils 57 and 59 are unlikely to fall off. The coils 57 and 59 are arranged in the gap of the magnetic circuit.

A coil wire 65 is spread over the face of the vibrating member 61 in a V shape, U shape, bellows shape or the combination thereof without providing negative effects on the vibration of the vibrating member 61. The coil wire 65 is attached with an elastic material such as adhesive provided in dots at random locations of the vibrating member 61. Accordingly, unstable operations at an acoustic mode are prohibited, reducing distortion components and preventing disconnection, caused by driving input voltage and long driving or the like. Furthermore, the coil wire 65 is connected to the terminal board 29 of a terminal block 41 provided at the periphery of the vibration transmitting portion 17 with the solder 31, and is covered with a protective agent 43 to protect the coil wire 65 and a connection part.

Moreover, by fixing the suspension 53 to the periphery of the yoke 11, the magnetic circuit is prevented from rocking. In order to prevent the magnetic circuit from contacting the vibrating member 61 because of excess amplitude from drop shock or the like, a stopper 45 is provided at the inner circumference of the vibration transmitting portion 17. One or more stoppers 45 are provided over the entire inner circumference.

At a vibration mode of the multi-functional vibration actuator of the present invention, the magnetic circuit and coils 57 and 59 that are fixed to the vibrating member 61, operate at an opposite phase due to mutual attraction and repulsion. Thus, a gap between the magnetic circuit or the suspension 53 and the vibrating member 61 is made larger than a gap between the magnetic circuit and the first cover 33 in consideration of the amplitude of the magnetic circuit and the vibrating member 61. Accordingly, the vibrating member 61 is prevented from contacting the magnetic circuit or the suspension 53.

In addition to the internal magnetic structure shown in the multi-functional vibration actuator of FIG. 4, the magnetic circuit may have the external magnetic or radial structure. Additionally, in case of either the internal magnetic structure or the external magnetic structure, the tips of the yoke 11 of the magnetic circuit are in the shape of protruding, projecting, recessed or the like so as to easily generate a high magnetic flux density. The magnetic pole of the permanent magnet 13 may face either direction. The suspension 53 is in one body with the vibration transmitting portion 17 by insert molding, welding, bonding, or the like.

Herein, the vibrating member 61 is in the shape of a flat, saucer, curved surface, corrugation or the combination thereof at a random plate thickness. In case of the curved surface, the curvature thereof is single or the combination of various curvatures, and furthermore, a random curvature to increase the rigidity of the vibrating member 61 at the inside of the coils 57 and 59 and to minimize high harmonic distortion components. Thus, at the vibration mode, the vibrating member 61 is prevented from contacting the magnetic circuit or the suspension 53. At the acoustic mode, predetermined acoustic characteristics may be obtained. The vibrating member 61 is formed of at least one plastic film material selected from the group consisting of polyether imide (PEI), polyethylene terephthalate (PET), polycarbonate (PC), polyphenylene sulfide (PPS), polyarylate (PAR), polyimide (PI) and aramid (PPTA).

Moreover, the periphery of the vibrating member 61 is coaxially mounted to the vibration transmitting portion 17 through an elastic material such as a tackiness agent, an adhesive and resin if necessary, so as to provide a larger amplitude of the vibrating member 61. The vibration transmitting portion 17 is made of resin or the like to provide elasticity.

The vibration transmitting portion 17 has the first cover 33 and the second cover 35 as protection for a functional part that provides vibrations. The first cover 33, fixed to the vibration transmitting portion 17, has one or more sound radiating holes 37 of a random diameter for air viscous damping action in order to prohibit the nonlinear unstable operations of the vibrating member 61 and to reduce high harmonic distortion components around resonance. The cover 33 is in the form of a circle, ellipse, flat oval, polygon or the combination thereof. It is also necessary to give attention to preventing air in-flow and outflow from anywhere besides the sound emitting holes 37 for air viscous damping action.

In the multi-functional vibration actuator of FIG. 4, the arrangement of a plurality of coils is shown as a first embodiment of a coil arrangement. In FIG. 4, the main coils 57 and the auxiliary coils 59 for correcting distortions are arranged in a vibrating direction at the side of the vibrating member 61 and at the side of the magnetic circuit, respectively. The coils are bonded to the vibrating member 61 with adhesive or the like in a bobbin form.

### EXAMPLE 2

Referring to FIG. 5A, in the multi-functional vibration actuator of Example 2 according to the present invention, a coil has a main coil 57 and an auxiliary coil 59. The main coil 57 is inserted into a recess 67 provided at a random location in the diameter direction of the vibrating member 61. Furthermore, the auxiliary coil 59 for correcting distortions is fixed with adhesive or the like to the top face of a projection formed by the recess 67 of the vibrating member 61.

Moreover, as shown in FIG. 5B, the auxiliary coil 59 for correcting distortion and the main coil 57 are inserted into the recess 67 in the vibrating direction of the vibrating member 61 at the side of the magnetic circuit and at the side of the vibrating member 61, respectively. Between the auxiliary coil 59 and the main coil 57, a projection 69 is provided at the recess 67.

Referring to FIG. 5C, the main coil 57 and the auxiliary coil 59 for correcting distortion are provided at the recess 67 of the vibrating member 61 parallel to the vibrating direction thereof.

Each coil is made of the same or different wire diameter, wire materials and so forth.

As described in reference to FIGS. 1 to 3, the single coils 25 are used in the conventional multi-functional vibration actuator.

In an electroacoustic transducer, magnetic gaps and the clearance of the coils 25 are necessary to provide stable operations of the coils 25 in a magnetic field. However, in the multi-functional vibration actuator in which a magnetic circuit is held with the suspension 53 and which generates vibrations by the vibration of the magnetic circuit during low frequency application, the coils 25 cannot operate accurately in accordance with applied signals. Thus, nonlinear vibrations are generated, and distortion characteristics become insignificant.

Accordingly, in the present invention shown in FIGS. 4 and 5, the auxiliary coils 59 for correcting distortions are added to the conventional coils (main coils) 57 to form the coil. Thus, even when the coils move out of a uniform magnetic flux distribution away from a magnetic gap, the auxiliary coils 59 function as distortion-improving coils. Thus, by raising the magnetic flux sensitivity of the coils as a whole, the coils may operate accurately in accordance with applied signals, and preferable distortion characteristics may be obtained.

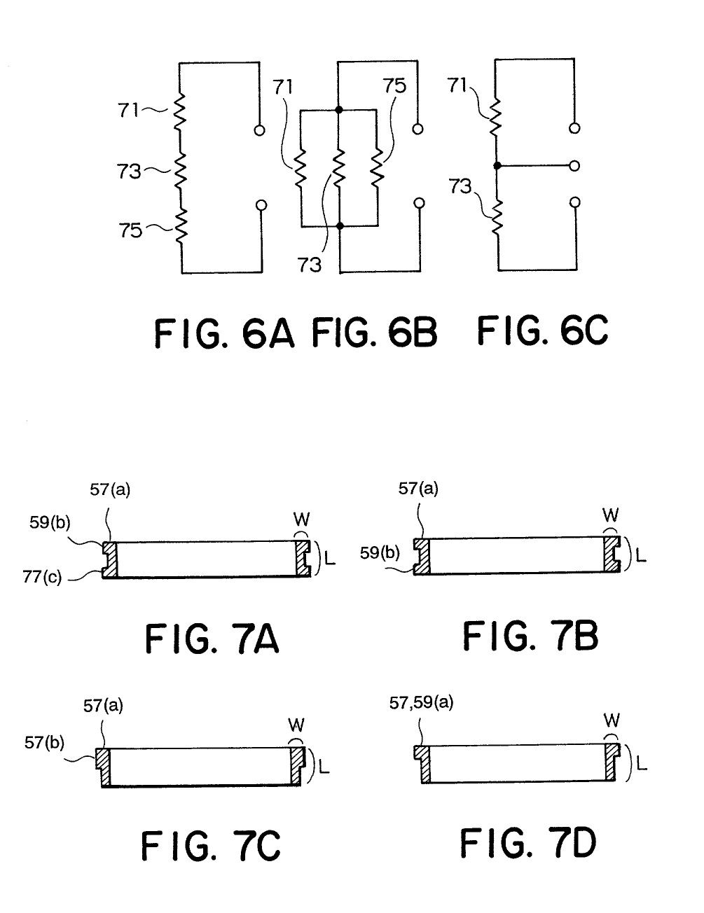

Moreover, each method shown in FIGS. 6A to 6C may be applied as the method of connecting wires.

In reference to FIG. 6A, coils 71, 73 and 75 are connected in series.

In FIG. 6B, the coils 71, 73 and 75 are connected in parallel.

Moreover, in reference to FIG. 6C, the coils 71 and 73 are connected in series, and terminals lead out from a node.

### EXAMPLE 3

A coil arrangement of the multi-functional vibration actuator of Example 3 according to the present invention will be explained.

As shown in FIG. 7A, a coil has the coil 57 and the auxiliary coil 59 wound in a certain way to have functions. At both ends in the height direction of the normally wound a coil (a) to act as the coil 57, two coils (b, c) to act as the coils 59 and 77 are wound.

As shown in FIG. 7B, the end at the side of the vibrating member 61 is densely wound with the coil (a) act as the coil 57, and the other end is wound with another coil (b) to act as the coil 59.

As shown in FIG. 7C, the normally wound coil (a) as the coil 57 is further wound with the coil (b) as the coil 59 at the side of the vibrating member 61.

Furthermore, as shown in FIG. 7D, the end at the side of the vibrating member 61 is densely wound with the coil (a) to form the coil 57 and the coil 59.

Herein, each coil, as shown in FIGS. 7A to 7D, is repeatedly non-densely and densely wound at random heights, i.e. number of lines, to differentiate winding widths, i.e. number of layers, and to add magnetic gradient. Thus, even when a moving coil jumps out of a uniform magnetic flux distribution of a magnetic pole gap, a uniform magnetic flux is always applied to at least one coil.

In this case, one or more coils are provided. The wire diameter, wire material and the like of each coil are the same or different from each other. When they are the same, coils are easily manufactured. When they are different, the characteristics of coils are easily designed, which is advantageous.

By simply winding coils in various ways without changing the shapes of coil installing parts of the vibrating member 61 as illustrated above, the decline in driving force is prevented and follow-up properties are kept even outside of a magnetic pole during driving. The nonlinearity of electric current with respect to driving force is also prohibited, so that no distortions are found.

When driving current is applied to the coils 57, 59, and 77, a magnetic circuit vibrates as the circuit is flexibly supported by the vibrating member 61 fixed to the vibration transmitting portion 17 and by the suspension 53. At this time, the vibration transmitting portion 17 becomes a solid part at low frequencies and an elastic member at high frequencies, and vibrates as a part of the vibrating member 61. The magnetic circuit and the coils 57, 59, and 77 fixed to the vibrating member 61 work at an opposite phase due to mutual attraction and repulsion. With the coils shown in FIGS. 4, 5A, 5B, 5C and 7A, 7B, 7C, 7D, the decrease in driving force may be prevented. Follow-up properties may be kept. The nonlinearity of electric current with respect to driving force may also be prohibited. Thus, distortion components may be reduced.

As described above, the present invention provides the multi-functional vibration actuator in which auxiliary coils for correcting distortions are provided to conventional single coils. Thus, the auxiliary coils work as distortion-improving coils even when the coils move out of a uniform magnetic flux distribution away from a magnetic gap. By raising the magnetic flux sensitivity of the coils as a whole, the decrease in driving force may be prevented and follow-up properties may be maintained. The nonlinearity of current with respect to driving force may also be prohibited. Accordingly, distortion components may be reduced. Additionally, the same results as mentioned above are obtained by repeatedly winding coils non-densely and densely at random heights, i.e. number of lines, differentiating winding widths, i.e. number of layers, and adding magnetic gradient to provide a uniform magnetic flux even during driving.

What is claimed is:

1. A multi-functional vibration actuator comprising a magnetic circuit flexibly supported by a suspension fixed to a vibration transmitting portion, a coil arranged at a gap of the magnetic circuit, and the vibration transmitting portion, wherein the coil comprises at least two coils.

2. The multi-functional vibration actuator according to claim 1, wherein the coil has at least one auxiliary coil so as to apply a uniform magnetic flux to the coil even when the coil jumps out of a uniform magnetic flux distribution range of a magnetic pole gap during driving.

3. The multi-functional vibration actuator according to claim 1, wherein the coil is fixed to a vibrating member; the vibrating member has a recess at a random location in a diameter direction; and the coil is inserted to the recess or fixed to a top face of a projection formed by the recess.

4. The multi-functional vibration actuator according to claim 1, wherein at least two coils are different in at least one of a wire diameter and a wire material.

5. The multi-functional vibration actuator according to claim 1, wherein at least two coils are connected in series or in parallel with two terminals or three terminals.

6. The multi-functional vibration actuator according to claim 1, wherein the coil has a coil wire wound densely at the side of the vibrating member to which the coi is fixed.

7. The multi-functional vibration actuator according to claim 1, wherein the magnetic circuit and the coil fixed to the vibrating member interact with each other to operate at an opposite phase.

8. The multi-functional vibration actuator according to claim 1, wherein said at least two coils are formed by a magnetic gradient by differentiating winding width at random height.
